(19) United States
(12) Patent Application Publication
(10) Pub. No.: US 2007/0065680 A1
(43) Pub. Date: Mar. 22, 2007

(54) Object with readily cleanable surface and process for the production thereof

(76) Inventors: Bernd Schultheis, Schwabenheim (DE); Inka Henze, Nieder-olm (DE); Todd Gudgel, Jugenheim (DE); Gerhard Weber, Bechenheim (DE)

Correspondence Address: Striker, Striker & Stenby, 103 East Neck Road, Huntington, NY, 11743, US

(21) Appl. No.: 10/576,119

(22) PCT Filed: Nov. 2, 2004
(86) PCT No.: PCT/EP04/12370

§ 371 Date: Apr. 18, 2006

(30) Foreign Application Priority Data
Nov. 4, 2003 (DE) 103 51 467.8

(51) Int. Cl. B05D 3/02; B05D 7/00; B05D 3/00; B05D 1/18; B32B 9/00

(52) U.S. Cl. 428/702; 427/402; 427/372.2; 427/430.1; 427/421.1; 427/532; 427/299

(57) ABSTRACT

The invention relates to objects, especially glass objects or glass ceramic objects, which are provided with a double coating to facilitate cleaning thereof. In order to ensure a coating that meets very strict test conditions developed for interior panes of baking ovens, said object comprises a double coating encompassing a hydrophobic outer layer that is provided with a component which reacts with a free OH group, and an inner inorganic sol-gel layer. The outer hydrophobic layer is applied to a highly reactive inner sol-gel layer that only begins to dry at moderate temperatures of up to a maximum of 100° C. and is firmly anchored thereto in a chemical manner by means of condensation reactions, whereupon the double-layer system is burned into the surface of the object at temperatures exceeding 50° C. The inventive method accordingly comprises the following steps: an inner inorganic sol-gel layer is applied directly to the surface of the object using conventional processes in a first step; the inner sol-gel layer is dried at a temperature ranging between room temperature and 100° C.; an outer hydrophobic layer that preferably contains fluoride compounds is applied to the reactive inner sol-gel layer using previously known processes in a second step; and the double-layer system is burned into the surface of the object.

The invention relates to an object with a readily cleanable surface obtained by double coating, the outer coating having a hydrophobic component capable of reacting with free —OH groups and the inner coating being an inorganic sol-gel coating.

Such objects can consist of a ceramic material, for example tiles, of sanitary ceramic products, of enamel for example baking oven muffles, of metals, for example alloyed steel, or of a plastic material. Objects made of glass or glass ceramics represent a preferred use, for example internal baking oven panes or transparent fireplace doors which are exposed to high temperatures and/or considerable soiling and must be cleaned all the time to enable them to function properly.

The invention also relates to a process for producing such coated objects.

There are a number of privately or commercially used objects that are exposed to major soiling, meaning that it is important that they be readily cleanable.

According to the prior art, objects exposed to soiling are typically treated either with hydrophobic solutions or they are provided with hydrophilic, photocatalytic coatings.

Hydrophobic surfaces can be produced in various ways. On the one hand, as in the ceramic industry, a coating consisting of an inorganic-organic nanoparticle network can be crosslinked thermally through unsaturated orga-nic groups or with UV light. Typical examples are inorganic-organic hybrid polymers of the Fraunhofer Institute for Silicate Research and known under the tradename ORMOCER®. On the other hand, there are many hydrophobic organic solutions that can be applied after fabrication or even by the final customer (for example solutions that have become known under the trade-name “Clear Shield®”). WO 00/37 374 provides an example of such a solution coating. These coatings are mechanically not very stable and are also limited by their organic component in terms of their maximum use temperature.

Hydrophilic photocatalytic coatings are offered, for example, by Pilkington (Aktiv Glas®) as readily cleanable facade glasses. To achieve a cleaning effect, activation with UV light is absolutely necessary. Moreover, the degradation rate of such coatings is very low and unsuitable for contact soil.

In practice, some of the use-specific requirements placed on the afore-said objects with readily cleanable surfaces are very difficult to meet. For example, the requirements placed on coatings for internal baking oven panes are as follows:
heat resistance of 300° C./100 h,
easy cleaning of diverse kinds of direct soil (for example cheese, ketchup, curds, food mixtures, pork belly, plum jam) at high temperatures (up to 300° C.),
mechanical resistance (erasing test, scrubbing test with conventional cleaning cloths or sponges, for example with a microfiber cloth),
chemical resistance to diverse cleaning agents, such as baking oven spray, rinsing agents, vinegar cleaners, and to foodstuffs.

No objects with readily cleanable surfaces are known that meet all aforesaid requirements. This is also true for objects and related fabrication processes according to EP 0 891 953 A1 and DE 100 18 671 A1 each of said objects having a double-coated surface.

DE 100 18 671 A1 discloses an object made, in particular, of glass or of a ceramic material and provided with a thin undercoating of a metal compound, particularly of an inorganic or organic compound preferably of a tetravalent metal such as Si, Al, Ti or Zr, which is applied to the surface of the object as a dispersion, by spraying or by dipping or as a powder spray, or else in the form of an appropriate sol or gel and is then baked on at a high temperature with decomposition of the organic parts. After cooling, an outer hydrophobic organic coating of a siloxane, silane, fluorosilanepolyurethane or tetrafluoropolyethylene is then applied to this coating by a known method and the coating is partly dried.

The EP document describes an object made of glass and provided with a first, undercoating of siliceous earth (silica) and a second, outer silane-containing hydrophobic coating. In the case of this object, too, the silica coating is baked before the hydrophobic coating is applied.

According to relevant experience, these known double coatings are not sufficiently stable during a cleaning process. As a result of the high baking temperatures which lead to a glassy under-coating, virtually all reactive groups in the undercoating react and are consumed by undergoing reactions so that chemical bonding with partners in the outer, hydrophobic coating is extremely slight.

The object of the invention is to provide the afore-said object with a coating capable of passing the above-indicated tests required for internal baking oven panes.

This objective is reached by way of an object with a readily cleanable surface obtained by double coating, the outer coating having a hydrophobic component capable of reacting with free —OH groups and the inner coating being an inorganic sol-gel coating. According to the invention, the outer, hydrophobic coating is applied to the highly reactive but only partly dried inner sol-gel coating at a moderate temperature of at the most 100° C. and is chemically firmly anchored to said coating by condensation reactions, and the double-coating system is baked onto the surface of the object at a temperature above 50° C.

According to the invention, the said objective is reached by way of a process for producing an object with a readily cleanable surface by double-coating, said process consisting of the following steps:
in a first step, applying an inner inorganic sol-gel coating directly onto the surface of the object by a conventional process,
drying the inner sol-gel coating at a temperature between room temperature and 100° C.,
in a second step, applying to the reactive inner sol-gel coating by a known process an outer, hydrophobic coating having a component capable of reacting with free
—OH groups, and
baking the double-coating system onto the surface of the object.

By the double-coating process of the invention, it is possible to produce objects with a visually inconspicuous, mechanically stable and readily cleanable protective coating. Because the under-coating, namely the inner sol-gel coating, is not subjected to baking, as is the case with known processes, but is first only partly dried at relatively moderate temperatures compared to the very high baking temperatures, the reactive groups, namely the —OH groups of the sol-gel coating, are retained and can form a chemical bond with the molecules of the hydrophobic top layer, particularly by a condensation reaction. Hence, essential for the invention is the highly reactive sol-gel undercoating, namely the inorganic sol-gel network, which through a condensation reaction becomes firmly anchored to the second coating. This second coating is highly hydrophobic and thus soil-repelling.

As is known, the sol-gel method is a method whereby it is possible to produce mechanically stable metal oxide coatings. To this end, a reaction of metal-organic starting materials in the dissolved state is used to form the coatings. By controlled hydrolysis and condensation reaction of the metal-organic starting materials, a typical metal oxide network structure is formed, namely a structure wherein the metal atoms are linked to one another by oxygen atoms, accompanied by the elimination of reaction products such as alcohol and water. The hydrolysis reaction can be accelerated by the addition of a catalyst.

The undercoating is thus a gel of metal-organic materials, the preferred metals in the case of the invention being Ti, Si, Zr, Al and Sn.

This coating typically has a thickness of 10 nm to 1 μm and is applied to the surface of the object to be coated, which preferably is a glass substrate, by a conventional process, and preferably by a spraying or dipping process. Besides spraying or dipping processes, all processes known to those skilled in the art can be used, for example spin-coating processes or vapor-deposition processes (VD, and preferably CVD processes).

According to another embodiment of the invention, the surface of the object is activated before application of the sol-gel coating. Many such activation processes are known to those skilled in the art, and they comprise oxidation as well as plasma treatments and treatment with an acid and/or an alkaline solution. It is also possible, before coating the object according to the invention, to apply to involved sites one or more adhesion-promoting coatings from the gaseous or liquid phase. Such adhesion-promoting coatings are numerous and are known to those skilled in the art, and they are easy to select for a particular substrate material. Common adhesion promoters are silanes and silanols that contain reactive groups. In individual cases, it is advantageous to first roughen the substrate surface, for example, mechanically by sand-blasting or chemically, for example by etching. Other physical methods such as corona discharge, flame treatment, UV treatment and combinations of the aforesaid procedures can also be used.

In a second step, after a drying time of preferably <6 hours at room temperature or at higher temperatures up to about 100° C. (see also Example 6), to this sol-gel coating is applied a hydrophobic coating, preferably a perfluorinated silane, having a thickness of <5 nm or a sol-gel mixture with a hydrophobic component and having a thickness of 5 nm to 1 μm and preferably 10 nm to 150 nm, the application being carried out by a known process, preferably by spraying.

The second coating preferably contains a fluoroalkylsilane as the hydrophobic component.

The silanes preferably used for the process according to the invention have the general formula
(CFₓH_{y})—(CFₐH_{b})ₙ(CF_{a′}H_{b′})ₘ—Si—(OR)₃
wherein x and y independently of each other denote 0, 1, 2 or 3 and x+y=3, a, a′ and b, b′ independently of each other denote 0, 1 or 2 and a+b=2 as well as a′+b′=2, and n and m independently of each other denote an integer from 0 to 20 and together amount to a maximum of 30, and R denotes a straight-chain or branched, saturated or unsaturated C₁-C₆-alkyl group (optionally bearing heteroatoms). Preferred alkyl groups are methyl, ethyl and propyl groups and the amino derivatives thereof. Preferred according to the invention are silanes containing hetero-atoms or heteroatoms-containing functional groups capable of increasing or promoting the water-solubility of the silane.

Before the spraying of the hydrophobic solution, the sol-gel coating must have firmed up sufficiently to prevent flow problems, for example to keep the coatings from contracting. The application of the hydrophobic spray solution to the partly dried, very reactive inner sol-gel coating gives rise to intensive penetration, coverage and cross-linking of the hydrophobic component with the inner sol-gel coating.

The double-coating system is then baked at 50-450° C. and preferably at 250-380° C. for 2 minutes to 2 hours.

The advantage of the process of the invention is that besides giving good cleaning results it appreciably reduces processing time.

By adjusting the spraying parameters, the flow time and drying time of the sol-gel coating can be controlled in a manner such that both coatings can be applied in a single spraying step by use of two spray heads. The energy-intensive baking of the undercoating, namely of the inner sol-gel coating, to form a glassy coating is not required.

### PRACTICAL EXAMPLES

### Example 1a

A SiO₂ undercoating on a glass substrate is prepared by mixing together for a short time equal amounts by weight of silicic acid ester and an alcoholic solvent. Then, 25 wt. % of water is added to the solution, and the solution is stirred for a short time with a small amount of catalyst (hydrochloric acid) and then allowed to stand for 1 day. For application, the concentrate prepared in this manner is once again diluted with alcohol, mixtures of 4 g of concentrate and 320 g of alcohol being particularly preferred for the spraying process.

### Example 1b

A mixed oxide undercoating was prepared by adding to the concentrate of Example 1a a concentrate of titanium in a weight ratio of 1:2. The titanium concentrate was prepared from TiCl₄ and ethanol which gave a solution of 128 g/L. Solutions applied by the spraying process were prepared by mixing 8 g of the SiO₂ concentrate with 4 g of the titanium concentrate and 320 g of alcohol.

### Example 2a

A hydrophobic coating was prepared by stirring together a hydrophobic silane (for example Degussa F8261) and a catalyst (acetic acid) in a weight ratio of 1:70 in acetone. This solution was then applied to the undercoating of Examples 1a and 1b.

### Example 2b

Another hydrophobic coating was prepared by stirring together for a short time equal amounts by weight of silicic acid ester and an alcoholic solvent. Then, 5 wt. % of a hydrophobic silane (for example, Degussa F8800) was stirred into the solution after which 22 wt. % of a mixture of water and a small amount of catalyst (hydrochloric acid) was added slowly with stirring. The resulting concentrate was then allowed to stand for 4 hours. A spray solution was prepared by mixing the concentrate with acetone in a weight ratio of 1:20. This solution was then applied to an intermediate coating obtained as in Examples 1.

### Example 3

Another hydrophobic coating system was obtained by applying a commercial hydrophobic solution capable of reacting with free —OH groups (for example, NanoTop® provided by Flexotec, or Easy-to-Clean products provided by Nano-X) to one of the undercoatings obtained in Example 1 and then applying it to a glass substrate by the process described in Example 4.

### Example 4

The undercoating as obtained in Examples 1 was applied to a heat-reflecting glass substrate by a conventional spraying process. To ensure good scatter, a microspray nozzle (provided by Krautzberger) was used. The undercoating was allowed to dry at room temperature.

The hydrophobic coating (Example 2) was applied to the partly dried undercoating with a micro-spray nozzle. The entire system was then baked at 300° C./20 min without decomposing the organic constituents, but so as to ensure that a very good (condensation) reaction occurred between and within the coatings and with the substrate.

### Example 5

To show the superiority of the unbaked bottom sol-gel layer of the coating system of the invention over a baked sol-gel coating of the prior art, two similar specimens were prepared and tested.

As in Example 1, a SiO₂ coating was applied to each of two equal substrates by spraying. One specimen was heated in the oven at 500° C. for 30 min whereas the other specimen was kept at room temperature under ambient conditions.

Both substrates were then coated with a fluorosilane by spraying as in Example 2 and then heat-treated at 300° C. for 20 minutes.

The two specimens were then tested by mechanically rubbing the coated surface with a wet felt pad under a 1-kg load. After a predetermined number of rubbing cycles, the contact angle of water on the rubbed surface was determined in both cases. As indicated in the following table, the specimen obtained according to the prior art and having a baked SiO₂ undercoating showed a rapid decrease in contact angle with the number of rubbing cycles compared to the second specimen coated according to the invention and devoid of a baked SiO₂ undercoating.

| | Contact Angle of Water | |
|---|---|---|
| Number of | Prior-Art SiO₂ Coating | SiO₂ Coating as per |
| Rubbing Cycles | Baked at 500° C. | Invention - Not Baked |
| 0 | 103 | 108 |
| 500 | 100 | 105 |
| 1000 | 68 | 96 |
| 1500 | — | 97 |

The results of the contact angle measurements were confirmed by XPS on the previously mechanically stressed sites. Thus, stoichiometric studies showed that the atomic fluorine content in the region of the XPS information-yielding depth (2-4 nm) for the specimen with the baked under-coating was only about one half that of the specimen of the invention which had not been baked before applying the second coating.

| XPS Measurement | | |
|---|---|---|
| at 45° C. | Prior Art, at % | Invention, at % |
| After 1000 cycles of | 10.2 | |
| mechanical stress | | |
| After 1500 cycles of | | 19.9 |
| mechanical stress | | |

As can be seen, the stability of the coatings is strongly dependent on the heat treatment of the undercoating. The coating system of the invention showed appreciable advantages in this respect.

### Example 6

To determine the optimum standing time before the hydrophobic outer coating was applied to the unbaked undercoating, specimens were prepared as in Example 2a but with different standing times. The standing times ranged from 5 minutes to 1 week under normal laboratory ambient conditions. A simplified baking oven cleaning test showed practically no differences in abrasion resistance of the double coating. In general, in view of the short processing times desired for economic reasons, the standing time should therefore be relatively short.

For other reasons, too, the standing time should not exceed a certain time period. To determine this limit, the afore-said comparative specimens (obtained with different standing times) were subjected to mechanical rubbing with a wet felt pad as in Example 5. The following table shows the contact angle obtained before and after 500 rubbing cycles for three specimens with standing times of 0.5, 6 or 24 hours before the application of the hydrophobic coating. As can be seen, for the specimen with a standing time of 0.5 hour, the contact angle showed practically no change and remained high. For the specimens with a standing time longer than 0.5 h, the contact angles decreased dramatically. For this reason, short standing times not in excess of 6 hours are preferred.

| Standing Time | Contact Angle of Water | After 500 Rubbing |
|---|---|---|
| (in Hours) | Before the Rubbing Cycles | Cycles |
| 0.5 | 108 | 105 |
| 6 | 108 | 61 |
| 24 | 105 | 59 |

So much for the practical examples.

The objects provided with the double coating of the invention can consist of ceramic material, for example of tiles or sanitary ceramic products, or they can consist of enamel, for example like the baking oven muffles, of metal, for example of a noble metal, or of a plastic material. A preferred application is represented by objects made of glass or glass-ceramic material, for example internal baking oven panes or transparent fireplace doors, all of which are exposed to high temperatures and/or major soiling and must be cleaned all the time.

1. Object with a surface that is easily cleanable as a result of being double-coated, with the outer coating containing a hydrophobic component capable of reacting with free —OH groups and the inner coating being an inorganic sol-gel coating, characterized in that the outer hydrophobic coating is applied to a very reactive inner sol-gel coating that has been only partly dried at a moderate temperature of at the most 100° C. and is chemically firmly anchored to it by condensation reactions, and only the double-coating system on the surface of the object is baked at a temperature above 50° C.

2. Process for preparing an object with an easily cleanable surface by double-coating comprising the steps of
applying an inner inorganic sol-gel coating directly to the surface of the object by a conventional process in a first step,
drying the inner sol-gel coating at a temperature between room temperature and 100° C.,
by a known process, applying to the reactive inner sol-gel coating in a second step an outer hydrophobic coating containing a component capable of reacting with free —OH groups, and
baking the double-coating system onto the surface of the object.

3. Process as defined in claim 2 whereby an inner sol-gel coating with a thickness of 10 nm to 1 μm is applied.

4. Process as defined in claim 3, whereby the inner sol-gel coating is applied by spraying or dipping.

5. Process as defined in claim 2, whereby the sol-gel coating is dried within a time period of preferably <6 h depending on the temperature used.

6. Process as defined in claim 2, whereby the surface to be coated is first activated, for example by a physical method such as corona discharge, flame treatment, UV treatment or plasma activation and/or by a mechanical method such as roughening or sand-blasting and/or by a chemical method, such as etching or applying one or more suitable adhesion-promoting coatings from the gas phase or liquid phase.

7. Process as defined in claim 2, whereby a perfluorinated silane or a sol-gel mixture with a perfluorinated silane is applied to the dried inner coating as the outer coating.

8. Process as defined in claim 7, whereby the outer coating is applied by spraying.

9. Process as defined in claim 4, whereby by controlling the flow time and drying time of the inner sol-gel coating the spraying parameters are adjusted so that both coatings are applied in a single spraying step.

10. Process as defined in claim 9, whereby the hydrophobic solution for the outer coating is applied to the forming, highly reactive inner sol-gel coating.

11. Process as defined in claim 2, whereby the double-coating system is baked at 50-450° C. for 2 min to 2 hours.

12. Object as defined in claim 1 and prepared as defined in claim 1, characterized in that it consists of a ceramic material, for example tiles or sanitary ceramic products, or it consists of enamel such as, for example, baking oven muffles, of metals, for example alloyed steel, of a plastic material or of glass/glass-ceramics such as, for ex-ample, internal baking oven panes or transparent fireplace doors which are exposed to high temperatures and/or considerable soiling and must be cleaned all the time to enable them to function properly.
